(19) United States
(12) Patent Application Publication
(10) Pub. No.: US 2010/0203969 A1
(43) Pub. Date: Aug. 12, 2010

(54) GAME DEVICE, GAME PROGRAM AND GAME OBJECT OPERATION METHOD

(75) Inventors: Hiroyuki Takahashi, Tokyo (JP); Shugo Takahashi, Tokyo (JP); Yusuke Sugimoto, Tokyo (JP); Haruki Kodera, Tokyo (JP)

Correspondence Address: MAIER & MAIER, PLLC, 1000 DUKE STREET, ALEXANDRIA, VA, 22314, US

(73) Assignee: Camelot Co., Ltd., Tokyo (JP)

(21) Appl. No.: 12/670,918

(22) PCT Filed: Aug. 1, 2008
(86) PCT No.: PCT/JP2008/063915

§ 371 Date: Jan. 27, 2010

(30) Foreign Application Priority Data
Aug. 3, 2007 (JP) 2007-203087

(51) Int. Cl. A63F 13/00; A63F 13/04

(52) U.S. Cl. 463/32; 463/36

(57) ABSTRACT

[Problems to be Solved] In a game where a user's operation is input to an object such as a player or a ball in a golf game or the like by using a controller with a built-in acceleration sensor to proceed the game, it is possible to input such a value at timing as the user intends without losing a realistic operation.

[Means for Solving the Problems] A game device, where an operation signal to operate a character displayed on a screen is input to proceed a game, is provided with a controller 1c that has an acceleration sensor to detect acceleration in a predetermined direction, a GUI control unit 24 that controls a graphic user interface 344 for the display and operation of the game, and an object control unit 252 that makes the coordinate position of a ball change in accordance with input data calculated on the basis of the operation signal input from the controller 1c.

### TECHNICAL FIELD

The present invention relates to a game device, a game program and a game object operation method, which receive user operation through a controller with a built-in acceleration sensor and have the game proceed with players or other objects displayed in a screen, for example, when playing in a 3D scene of a sports game such as a golf game, a tennis game or a baseball game, or a 3D scene of a role playing game.

### BACKGROUND ART

Conventionally, television games have been developed in many ways, for example, as home video game dedicated machines, coin-operated arcade game machines and the like, and also as game software which can be run by a general-purpose computer such as a personal computer. On the other hand, with the recent advances in the communications infrastructures, game programs provided through a communication network such as the Internet have become popular as distributed by the so-called online gaming services, which are taking place the conventional distribution through recording mediums such as CD-ROM.

One of the above games is a sports simulation game such as a golf game which proceeds on various conditions as given, for example, the shooting direction, the magnitude of impact, the strike point and other set values relating to the operation of the player, which are input when a player makes a shot. These various conditions are input through a graphic user interface (GUI) displayed in a screen with an input interface such as a mouse or a controller of the game device.

Meanwhile, in recent years, controllers have been developed which are provided with acceleration sensors capable of detecting acceleration in a predetermined direction to input the various conditions in accordance with the acceleration detected by the acceleration sensors, and TV television game machines and game software have been developed for use in playing with the controllers.

When playing this kind of TV television game with such a controller, the operation of the controller can be traced with a player displayed in a screen such that it is possible to feel more realistic operability.

On the other hand, in correspondence with shooting motions of golf, it is necessary to acquire several conditional parameters on the basis of a plurality of motions such as a swinging motion, i.e., swinging down after the take back motion for swinging back a golf club, a shooting motion, i.e., hitting a ball, and so forth respectively with appropriate timing.

The prior art as described above allows an operator to press an enter button during operation for recognizing most remarkable operation (maximum acceleration) and determining various parameters with arbitrary timing (for example, refer to Non Patent Literature 1).

Non Patent Literature 1: Nintendo website “Wii Sports—Wii”, [online], [Search on Jul. 6, 2008], Internet <URL: http://www.nintendo.co.jp/wii/rspj/5sports/golf.html>, Nintendo Co., Ltd.

### DISCLOSURE OF THE INVENTION

### Problem to be Solved by the Invention

However, since the operator takes a motion as a flow of a plurality of operational steps, a change between one motion and another cannot be precisely detected only by calculating a maximum acceleration so that there is a problem in that an input is done with different timing than the operator has intended. On the other hand, in the case where the operator presses the enter button with arbitrary timing, while an input is done with appropriate timing the operator has intended, there is a problem in that the motion becomes very different from the motion during playing real sports to deteriorate realistic operability.

The present invention has been made in order to solve the problems as described above, and it is an object to provide a game device, a game program and a game object operation method for a game where a user's operation is input to an object such as a player or a ball in a golf game or the like by using a controller with a built-in acceleration sensor to proceed the game, wherein it is possible to input such a value at timing as the user intends without losing a realistic operation.

### Means to Solve the Problems

In order to accomplish the object as described above, the present invention provides a game device for proceeding with a game by inputting an operating signal to operate an object displayed in a screen, comprising: a controller provided with an acceleration sensor for detecting acceleration in a predetermined direction and configured to output the operating signal in accordance with the acceleration detected by the acceleration sensor; a user interface control unit configured to control a graphic user interface which is arranged in the screen and used to the display and operation of the game; and an object control unit configured to change the object in accordance with input data which is calculated on the basis of the operating signal input through the controller.

The input data is generated from a first operating signal indicative of an input value which varies in accordance with the motion of an operator of the controller and a second operating signal for modifying the input value. Furthermore, the graphic user interface comprises: a first graphic representation indicative of the input value by changing an image in response to the first operating signal as input; a second graphic representation indicative of determination of the input value indicated by the first operating signal and the start of accepting the second operating signal by changing an image; a third graphic representation indicative of the accepting of the second operating signal and the timing of modifying the input value determined by the second graphical representation.

The game object operation method of the present invention provided with the following steps can be implemented by operating the game device having the structure as described above.

Namely, the game object operation method of the present invention is performed for proceeding with a game by: using a controller provided with an acceleration sensor for detecting acceleration in a predetermined direction and configured to output the operating signal in accordance with the acceleration detected by the acceleration sensor; operating an object displayed in a screen through a graphic user interface which is arranged in the screen and used to the display and operation of the game; and changing the object in accordance with input data which is calculated on the basis of the operating signal input through the controller, in which the following steps are taken:

(1) an input start step of inputting a first operating signal indicative of an input value which varies in accordance with the motion of an operator of the controller and indicating the input value with a first graphic representation by changing an image in response to the first operating signal as input;
(2) an input value determination step of changing an image as a second graphic representation to determine the input value indicated by the first operating signal and indicate the start of accepting the second operating signal;
(3) an input value modification step of changing an image as a third graphic representation to accept the second operating signal and indicate the timing of modifying the input value determined by the second graphical representation; and
(4) an input data calculation step of generating the input data from the input value which is indicated by the first operating signal and varies in accordance with the motion of the operator of the controller, by modifying the input value in accordance with the second operating signal.

Incidentally, the game device and game object operation method can be implemented by running the game program of the present invention written in a predetermined language on a computer.

That is, the game program is run for proceeding with a game by: using a controller provided with an acceleration sensor for detecting acceleration in a predetermined direction and configured to output the operating signal in accordance with the acceleration detected by the acceleration sensor; operating an object displayed in a screen through a graphic user interface which is arranged in the screen and used to the display and operation of the game; and changing the object in accordance with input data which is calculated on the basis of the operating signal input through the controller, by causing a computer to perform:

(1) an input start step of inputting a first operating signal indicative of an input value which varies in accordance with the motion of an operator of the controller and indicating the input value with a first graphic representation by changing an image in response to the first operating signal as input;
(2) an input value determination step of changing an image as a second graphic representation to determine the input value indicated by the first operating signal and indicate the start of accepting the second operating signal;
(3) an input value modification step of changing an image as a third graphic representation to accept the second operating signal and indicate the timing of modifying the input value determined by the second graphical representation; and
(4) an input data calculation step of generating the input data from the input value which is indicated by the first operating signal and varies in accordance with the motion of the operator of the controller, by modifying the input value in accordance with the second operating signal.

In accordance with the above inventions, it is possible to determine the timing with the controller having the built-in acceleration sensor, even in the case where a plurality of motions are input as a set of motions such as a take-back motion, a swinging motion and a shooting motion in a golf game, by detecting only the start and end of the motions as the first operating signal and the second operating signal and detecting the timing of switching the motions on the basis of the change in the second graphic representation, and thereby it is possible to dispense with the operation, for switching between the motions, which is unnecessary when actually doing sports, and acquire important operating signals which determine input data by more similar motions as in actually doing sports.

In the invention as described above, it is preferred that a character moves in the screen as the object, that the character starts a motion following the motion of the operator of the controller on the basis of the first operating signal, and that the second graphic representation indicates the determination of the input value and the start of accepting the second operating signal by difference or synchronization between the motion of the operator and the motion of the character. In this case, the operating signal relating to the next operation is accepted on the basis of the synchronization between the motion of the operator and the motion of the character in the screen, and thereby the operator can spontaneously switch to the next motion for inputting an operating signal while feeling the sense of identity to the character in the screen.

In the invention as described above, it is preferred that the second graphic representation is provided to display the time elapsed after the first operating signal is input, and indicate the determination of the input value and the start of accepting the second operating signal when the elapsed time reaches a predetermined time. In this case, it is possible to provide a simple representation of switching between motions in an easy-to-understand manner by indicating switching from a first motion to the next motion with reference to the elapsed time of a timer or the like.

In the invention as described above, it is preferred that a fourth graphic representation is provided in the input value modification step to further display change in the input value on the basis of the acceleration contained in the second operating signal. In this case, it is possible to acquire not only the timing of inputting but also the power (extent) of the motion when accepting the second operating signal, and notify the operator of the result of acquisition to diversify the game scenario.

In the invention as described above, it is preferred that the first graphic representation is provided to display a limit on the input value in accordance the state of the object. In this case, for example, when playing a golf game, the maximum value of the second operating signal is limited in accordance with the lie the ball is located (the states and conditions of grass and land form around the location), and thereby it is possible to adequately adjust difficulty in inputting operation and make the game more exciting without compromising spontaneous operability of the operator.

In the invention as described above, it is preferred that the game is played in a virtual three-dimensional space in which a virtual camera is located to take an image which is displayed in the screen, that the controller is provided with a camera control function for controlling the imaging direction of the virtual camera in accordance with the acceleration detected by the acceleration sensor, and that user operation is analyzed to switch between the camera control function and a signal acquisition function for acquiring the first operating signal. In this case, it is possible to smoothly input stroke data and switch the screen only by simply motion such as swinging or tilting the controller, and thereby the operability can be furthermore improved.

In the invention as described above, it is preferred that a ball changes its position as the object in accordance with input data at least indicative of the magnitude and direction of impact, and that the graphic user interface is provided to point to an estimated arrival point of the ball at which the operator aims in the three-dimensional space, display an image to indicate the magnitude of impact on the ball as a target power required in accordance with the distance to the target point on the first graphic representation, and display an estimated flight path of the ball in association with the target power indicated on the first graphic representation. In this case, for example, when playing a golf game or the like by hitting a ball, the operability can be improved by displaying a flight path the user desires.

In the invention as described above, it is preferred that a ball changes its position as the object in accordance with input data at least indicative of the magnitude and direction of impact, that the controller detects the inclination of the controller itself in relation to the direction of gravity by the acceleration sensor, that the estimated flight path of the ball is displayed in the screen in advance of the input start step such that the estimated flight path is modified in accordance with the inclination of the controller itself in relation to the direction of gravity, and that the input data is modified in the input data calculation step on the basis of the estimated flight path which is changed. In this case, for example, when a golf game is played by such operation that the flight path changes (for example, fade or draw) depending upon how to grip a golf club, it is possible to make the operation more realistic and improve operability by displaying an estimated change in the flight path in an easy-to-understand manner.

### EFFECT OF INVENTION

As has been discussed above, in accordance with the present invention, when playing a game where a user's operation is input to an object such as a player or a ball in a golf game or the like by using a controller with a built-in acceleration sensor to proceed the game, it is possible to input such a value at timing as the user intends without losing a realistic operation.

### BEST MODE FOR CARRYING OUT THE INVENTION

### Configuration of Game Device

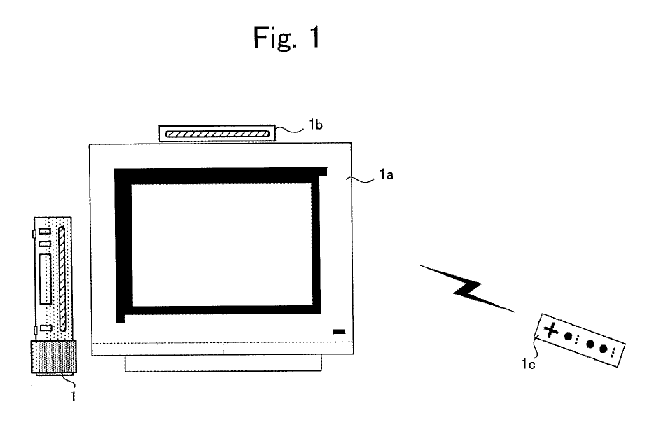

An embodiment of the present invention will be explained with reference to the accompanying drawings. FIG. 1 is a view for schematically showing the system configuration of a game apparatus in accordance with the present embodiment. Incidentally, the example of the present embodiment is described in the case where golf game software is run on a gaming hardware 1. Also, while the present invention is applied to the golf game software in the case of the present embodiment, the present invention is not limited thereto, but also applicable to, for example, sports games such as a tennis game and a baseball game, role-playing games including 3D scenes, and any other game software for receiving user operation and having the game proceed with players or other objects displayed in a screen.

The game apparatus according to the present embodiment is connected to a display 1a, as illustrated in FIG. 1, and used to operate objects displayed in the screen of this display 1a for proceeding with the game. These objects include characters such as a player who plays the golf game in a game scenario, a ball hit by the player, a virtual camera for imaging the three-dimensional space and so forth.

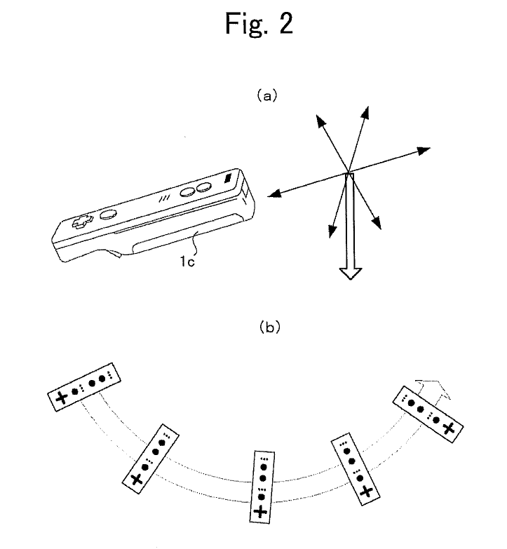

On the other hand, the gaming hardware 1 is provided with a wireless controller 1c capable of transmitting and receiving signals through radio communication as an input device for operating the above objects. This controller 1c includes a built-in acceleration sensor which detects accelerations in the directions of three axes in order to detect the acceleration of the controller 1c in each direction as illustrated in FIG. 2(a) and FIG. 2(b), and outputs operating signals to a communication interface 27 of the gaming hardware 1 in correspondence with the accelerations detected by this acceleration sensor. The direction of gravity exerted on the controller 1c can be detected on the basis of the operating signals output from this controller 1c, and the inclination of this controller 1c can be detected on the basis of this direction as a reference. Also, a motion can be detected on the basis of the centrifugal force exerted on the controller 1c, for example, when swinging a bat, a tennis racket or a golf club. Meanwhile, this controller 1c can be connected with a vibrator, a sound output device, a light emitting device such as an LED, or the like accessory, which is driven in accordance with a control signal transmitted from the gaming hardware.

The display 1a is a device which receives image signals and sound signals transmitted from the gaming hardware 1 for enabling viewing of the game screen and listening of the associated sound. Then, a graphic user interface 344 is displayed in the screen of the display 1a for performing the display and operation of the game. The operator can perform the operation of a character through this graphic user interface 344.

The gaming hardware 1 is an arithmetic processing unit equipped with a CPU which can be realized with a general purpose personal computer such as a personal computer or a dedicated device specialized with necessary functions. The gaming hardware 1 may be a mobile computer, a PDA (Personal Digital Assistance) or a cellular phone.

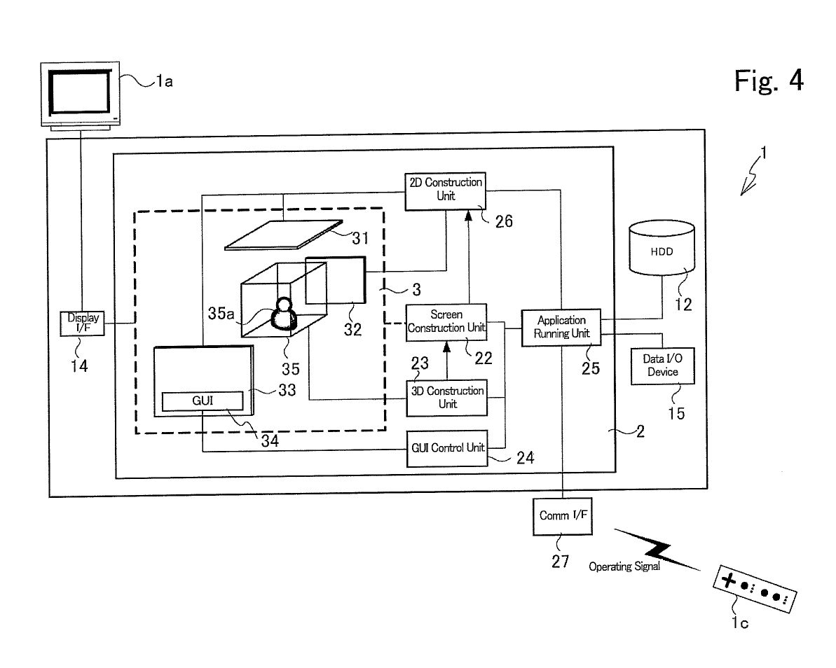

As illustrated in FIG. 4, this gaming hardware 1 comprises a CPU 2 for performing arithmetic operations, a storage device 12 such as a hard disk for storing data and programs, a display interface (I/F) 14 for connecting a display device such as a display 11, a data input/output device 15 for inputting and outputting data in a recording medium such as a CD-ROM, a DVD-ROM or a memory card, a communication interface (I/F) 27 for communicating with an input device such as a wireless controller 1c, a light receiving device 1b and so forth.

A variety of modules are built by driving the CPU 2 to run a golf game software. In the context of this document, the term “module” is intended to encompass any function unit capable of performing necessary operation, as implemented with hardware such as a device or an apparatus, software capable of performing the functionality of the hardware, or any combination thereof. More specifically described, the CPU 2 runs the golf game software to build a screen construction unit 22, a 3D configuration unit 23, a GUI control unit 24, an application running unit 25 and a 2D configuration unit 26.

The application running unit 25 is a module for running the programs of the golf game software to proceed with the golf game by making use of objects which are arranged in a 3D virtual space 3. More specifically speaking, the application running unit 25 performs the progress management of the game in accordance with the rules of golf (OB is counted as one penalty stroke; when there are a plurality of players, each player takes a shot in a controlled order; and so forth), the score management on the basis of progress of the golf game, and the arithmetic operation necessary for ballistic simulation of the projectile in the virtual space by calculating the condition of a ball which is struck in accordance with stroke analysis on the basis of the ability parameters of the character and the properties of items, such as a golf club, which are used and selected by each user.

Incidentally, while a virtual three-dimensional space 3 is constructed as a three-dimensional representation to make alive the scene and the like in the case of this golf game program, since the display 1a the user views is two-dimensional, the interface is provided for helping the user to spatially recognize the space by automatically performing the camera work which is moved in the vertical plane along the shooting direction, representing this plane in association with a power gauge, and so forth.

Then, the golf game program receives an operating signal generated by the user operation through the communication interface 27 and the controller 1c, proceeds with the game in accordance with the condition (input data) acquired in response to the operating signal, generates display information items (3D polygons and so forth), displays the imaging screens 31 to 33 as two-dimensional planes in correspondence with various viewing directions, and outputs sound associated with the display.

The 3D configuration unit 23 is a module for virtually constructing the three-dimensional space, and controlling the position coordinates of the objects and the cameras located in the three-dimensional coordinate system 35 in this three-dimensional space 3. The 2D configuration unit 26 is a module for two-dimensionally displaying the three-dimensional space 3 in the imaging screens 31 to 33 in accordance with the field-of-view range of each of the imaging screens 31 to 33 on the basis of the type, area and shape of each imaging screen.

The screen construction unit 22 is a module for acquiring the data of the three-dimensional space 3 constructed by the 3D configuration unit 23, having the 2D configuration unit 26 to perform arithmetic operation of the two-dimensional images in the viewing directions on the basis of user operation, and controlling the imaging screens 31 to in correspondence with various viewing directions. Specifically speaking, while virtual cameras are provided for setting the field-of-view ranges in the three-dimensional space 3, the objects imaged by the virtual cameras respectively are displayed in the imaging screens 31 to 33 by the 2D configuration unit 26 respectively as two-dimensional planes on the basis of the positional relationship between the objects and the virtual cameras calculated by the 3D configuration unit 23. Meanwhile, in the case of the present embodiment, the imaging screen 33 is a main screen showing the shooting motion of a player in a full view of a golf course. The main screen includes the GUI 34. Also, the imaging screen 32 is a jump screen in which is imaged the location near the arrival point of the ball, and the imaging screen 31 is a top screen in which is imaged the golf course viewed from above as a bird's-eye view.

The GUI control unit 24 is a module for controlling the graphic user interface (GUI) which is located in the imaging screens 31 to 33 (mainly in the main screen 33 in the case of the present embodiment) for displaying information about the game and enabling the user to perform operation. In the case of the present embodiment, the golf game proceeds in response to the operation of an object (character, ball or the like) displayed in the display 1a through the GUI by the use of the input device 1c.

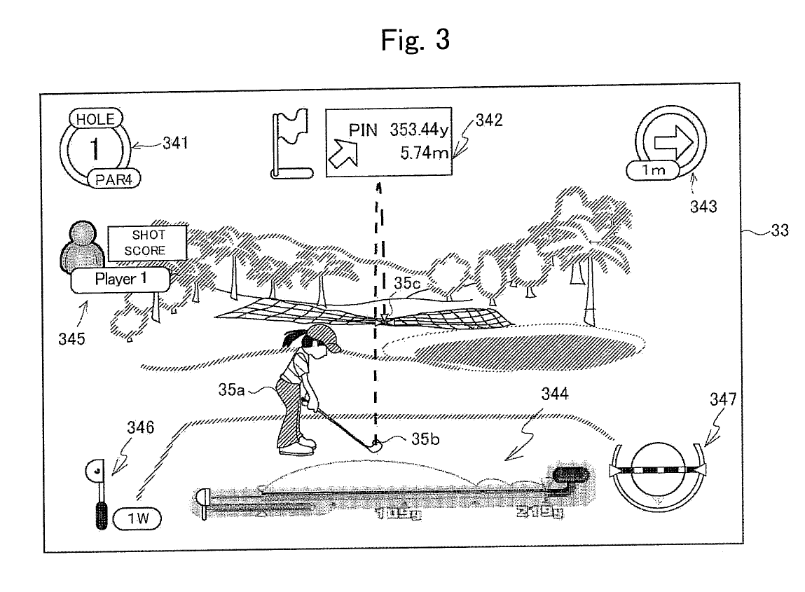

The GUI 34 comprises graphics mainly displayed in the main imaging screen 33, for example, as an icon 341 indicative of the progress of the golf game (hole number and par type), an icon 342 indicative of the distance and direction to the pin, an icon 343 indicative of how the wind blows, icons 345 indicative of the name and score of the player, an icon 346 indicative of the golf club the player has selected, an icon 347 indicative of the state of the ball, an icon 344 which is operated when striking the ball, and so forth, as illustrated in FIG. 3.

Meanwhile, in the case of the present embodiment, the icon 347 indicative of the state of the ball represents a change in the spin of the ball responsive to the user operation, i.e., a rotation image of the ball when the ball is struck in the current condition, for example, the type of lie where the ball is located (fairway, rough, bunker or the like), the variations in ball behavior (for example, ±3%), the slope angle of the lie (toes pointed uphill or downhill, left foot pointed uphill or downhill, and so forth). Also, in addition to this, the strike point which is variable corresponding to user operation may be displayed in the icon 347.

In the case of the present embodiment, the user operations input through this controller 1c include the striking power and direction of a golf ball 35b which is hit by a character 35a (the strike point on the surface of the ball, face angle, spinning operation and shooting timing). The parameters related thereto are input through the operation of the GUI 34 (mainly the icon 344) as input data, and the golf ball 35b which is one of the objects changes in the object coordinate position of the three-dimensional space 3 on the basis of the input data. Incidentally, the input data for shooting operation can be calculated on the basis of a first operating signal as an input value (maximum input value) which varies in response to the operation of the operator of the controller 1c, and a second operating signal as a modification value which changes the maximum input value (shooting timing, face angle, and the magnitude of swinging the controller).

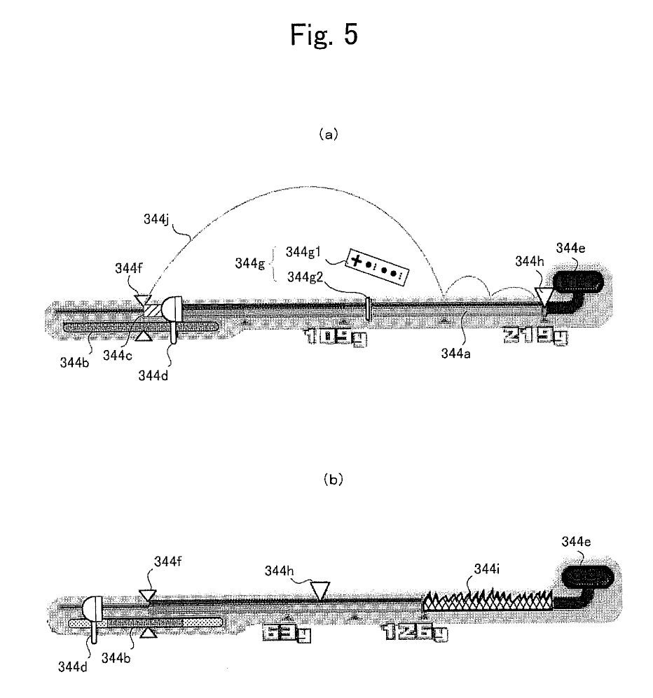

Describing the icon 344 in detail, as illustrated in FIG. 5(a) and FIG. 5(b), the icon 344 mainly comprises a gauge line 344a which is partitioned into a plurality of areas indicative of the estimated flying distance, a meeting area 344b indicative of the effective range of shooting operation on the gauge line 344a, a power gauge 344c indicative of the magnitude of impact on the gauge line 344a, an impact pointer 344d indicative of the synchronization delay in relation to the character, and a power shot gauge 344e indicative of the additional magnitude of impact in accordance with the acceleration during the shooting motion. Incidentally, this graphic user interface 344 can be reversed in the left-right direction in accordance with user operation such that the graphical representation can be changed in the direction conforming with the dominant hand of the user.

The gauge line 344a is a graphical representation for displaying the maximum value of the magnitude of impact as input (estimated flying distance), and provided with a target point 344h indicative of the magnitude of impact the user desires, a shot point 344f indicative of appropriate shooting timing, and a controller icon 344g indicative of the state of the controller operated by the operator. The controller icon 344g is a first graphical representation for displaying the input value as an image which changes in response to the first manipulation signal, and provided with an icon 344g1 for informing the operator of how to use the controller, an icon 344g2 for representing the length of take-back motion in accordance with the acceleration and inclination of the controller 1c. This controller icon 344g moves (changes) its horizontal direction as the first graphical representation in accordance with the first operating signal (the acceleration and inclination of the controller 1c).

Incidentally, the controller icon 344g can moves as the first graphical representation beyond the gauge line 344a and reach the power shot gauge 344e. A power shot can be done by moving the controller icon 344g to the power shot gauge 344e.

When a target icon 35c is moved to an arrival point in the 3D golf course in advance of starting a shooting motion, the target point 344h moves on the gauge line 344a in accordance with the distance between the player and the target icon 35c. The target icon 35c serves as an indication pointing to an estimated arrival point at which the operator aims in the three-dimensional space 3. An estimated flight path of the ball is illustrated between the position of the character 35a and the estimated arrival point.

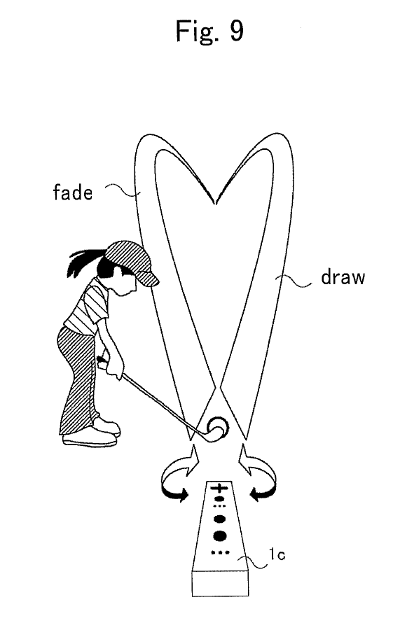

The estimated flight path is modified and displayed in accordance with the inclination of the controller 1c with respect to the direction of gravity as illustrated in FIG. 9, and the input data changes on the basis of the estimated flight path which is modified. Namely, in the case of the golf game of the present embodiment, the flight path changes (for example, fade or draw) depending upon how to grip, and is used to calculate the flying distance, course, required magnitude of impact of the ball and so forth.

The target point 344h is displayed to indicate the required magnitude of impact on the ball in accordance with the distance to the target icon 35c as a target power on the gauge line 344a. The estimated flight path of this ball is displayed as an estimated flight path 344j in association with the target power on the gauge line 344a. Meanwhile, this estimated flight path 344j is a line plotted by projecting the estimated flight path onto the vertical surface in the three-dimensional space 3, and scaled in accordance with the length and display unit of the gauge line 344a (the maximum distance). The estimated flight path 344j is displayed to show not only the flight path but also change in the course (route) on the basis of obstacles, land form and the like.

The shot point 344f indicates an appropriate shot point on both the gauge line 344a and the meeting area 344b displayed therebelow. The meeting area 344b indicates the most effective shooting range in the vicinity of the shot point 344f. This effective shooting range changes in size in accordance with the type of crab the user selected and the lie the ball is located.

On the other hand, the gauge line 344a and the power gauge 344c are graphical representations indicative of the magnitude of impact actually input, and extended in accordance with the position of the impact pointer 344d to indicate the maximum input value of the magnitude of impact by the length (scale mark of the gauge line 344a). Furthermore, a limit on the maximum input value is indicated in the gauge line 344a in accordance with the conditions of the objects, i.e., the lie the ball is located (the states and conditions of grass and land form around the location). More specifically speaking, as illustrated in FIG. 5(b), the end of the gauge line 344a is provided with a texture 344i displayed to represent the lie over which the power gauge 344c cannot be extended so as to pose the limitation on the maximum value of the magnitude of impact which can be input. This texture 344i changes in length and image in accordance with the condition of the lie. For example, when the ball is located in a bunker, rough or the like, a sand image or grass field image is selected as the texture 344i whose length is adjusted in accordance with the difficulty level.

The impact pointer 344d serves as a second graphical representation indicative of determination of the input value indicated by the first operating signal during the take-back motion of a shot and the start of accepting the second operating signal by changing an image when the take-back motion is switched to an swinging motion to indicate the start timing of accepting the second operating signal, and further serves as a third graphical representation indicative of the accepting of the second operating signal and the timing of modifying the input value determined by the second graphical representation. Namely, more specifically speaking, the impact pointer 344d moves as the first graphical representation in the rightward direction on the gauge line 344a to follow the controller icon 344g, reverses the motion as the second graphical representation after catching up with the controller icon 344g, and stops as the third graphical representation with timing (power) when a shooting motion is taken.

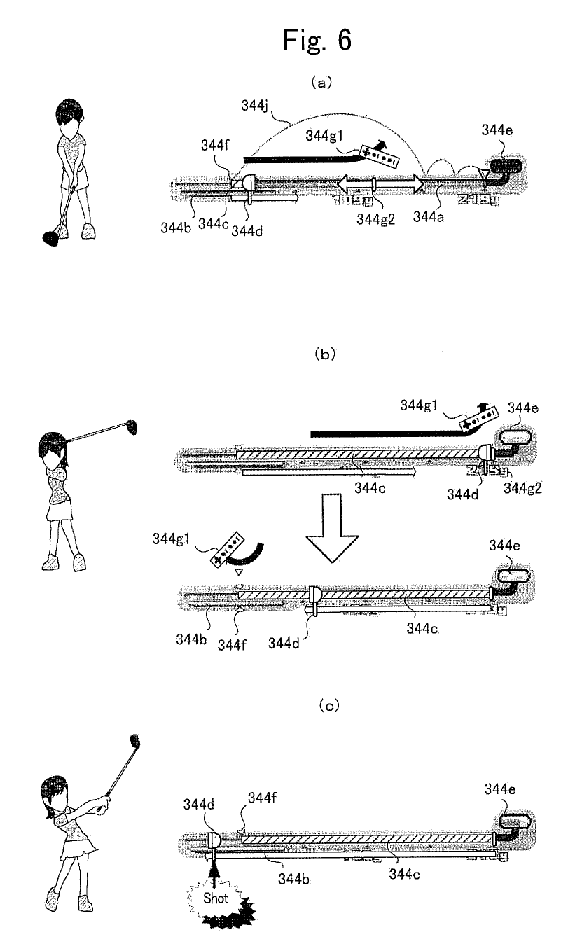

Describing in detail, as illustrated in FIG. 6(a), the controller icon 344g2 moves as the first graphical representation in the right and left direction in accordance with the first operating signal corresponding to the inclination of the controller 1c. At the same time, the character of the player slowly begins to take a motion following the motion of the operator on the basis of the first operating signal as input, and while the impact pointer 344d moves, the power gauge 344c is extended. In this case, the controller icon 344g2 is displayed to give the user an image of the operation method of the controller 1c (inclining).

Next, as illustrated in the same figure (b), the following motion of this character is represented by the delay (difference) of the impact pointer 344d (the power gauge 344c) from the controller icon 344g2. Then, when the motion of the character is synchronized with the motion of the operator, i.e., the impact pointer 344d catches up with the controller icon 344g2 as the second graphical representation, the motion is automatically switched to the swinging motion, and the impact pointer 344d reverses its motion to start moving toward the shot point 344f and start accepting the second operating signal. The operator can change the position of the controller icon 34491, just before reversing the motion, by changing the inclination of the controller 1c to adjust the timing of synchronizing with the character, i.e., the input value of the magnitude of impact. Also, during reversing the motion, the way of displaying the controller icon 344g2 is switched to notify the user of the operation “swing”.

Thereafter, as illustrated in FIG. 6(c), the impact pointer 344d reverses and starts moving toward the shot point 344f, and if the operator takes a shot by swinging the controller 1c while the impact pointer 344d is moving in the meeting area 344b, the second operating signal is input so that the impact pointer 344d stops in the time (power) position corresponding to the input timing to complete the shooting motion. Meanwhile, the speed of swinging the controller 1c during a shot is calculated on the basis of the distribution and accumulated value of the second operating signal acquired while the impact pointer 344d is moving in the meeting area 344b.

The power shot gauge 344e is a fourth graphical representation indicative of change in the input value on the basis of the magnitude of acceleration contained in the second operating signal. The maximum magnitude of impact, which has been modified in accordance with the shot timing, is further modified and increased in accordance with the speed of swinging the controller 1c during a shot followed by showing an power increment just after the shooting motion.

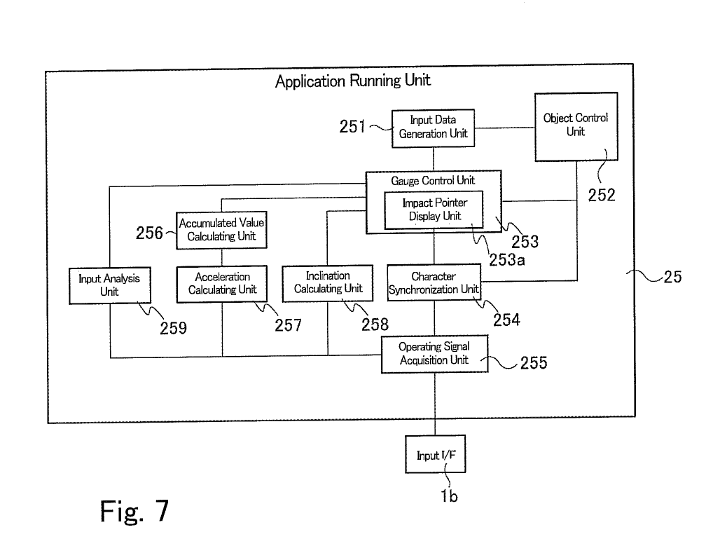

The input data of the magnitude of impact on this golf ball 35b is arithmetic processed by the application running unit 25 to proceed with the game in accordance with the changing position of the golf ball 35b. FIG. 7 is a block diagram for showing the configuration of a stroke data input system of the application running unit 25.

The application running unit 25 is provided with an operating signal acquisition unit 255 as a module for acquiring and arithmetic processing an operating signal which is input from the controller 1c. The operating signal acquisition unit 255 is connected with an acceleration calculating unit 257 and an inclination calculating unit 258 for calculating the acceleration and inclination of the controller 1c on the basis of the operating signal, an input analysis unit 259 for analyzing the operating signal input through devices such as buttons and keys other than sensors, and an accumulated value calculating unit 256 for calculating the accumulated value of signals within a predetermined time period.

The operating signal acquisition unit 255 is a module for acquiring and determining a variety of operating signals and dispatching the values of the operating signals to the modules that need these values respectively, in order to receive the first operating signal indicative of starting a shooting motion and the second operating signal indicative of inputting the magnitude of impact. The acquired operating signals are input to a gauge control unit 253 through a character synchronization unit 254.

The acceleration calculating unit 257 and the inclination calculating unit 258 are modules for calculating the centrifugal force exerted on the controller 1c and the rotation and inclination of the controller 1c on the basis of the accelerations in the directions (X-axis, Y-axis, Z-axis) respectively detected by the acceleration sensor located in the controller 1c. Particularly, the inclination calculating unit 258 determines the direction of gravity exerted on the controller 1c and calculates the inclination in relation to the direction of gravity. Also, the accumulated value calculating unit 256 is a module for obtaining the accumulated value of the operating signals which have been acquired in the predetermined period. For example, this accumulated value calculating unit 256 can calculate the magnitude of impact by obtaining the accumulated value of the second operating signal in the meeting area 344b. In this way, while it is possible to detect the acceleration continuously exerted for a predetermined period and prevent false detection of operation, the operator has to maintain the acceleration for a predetermined period and is required to perform large motion rather than short motion, resulting in an improved likeness to real sports.

The input analysis unit 259 is a module for detecting operating signals acquired from devices other than the acceleration sensor, for example, to extract and output a voice input signal or a button operating signal of the controller 1c to the gauge control unit 253 and other modules.

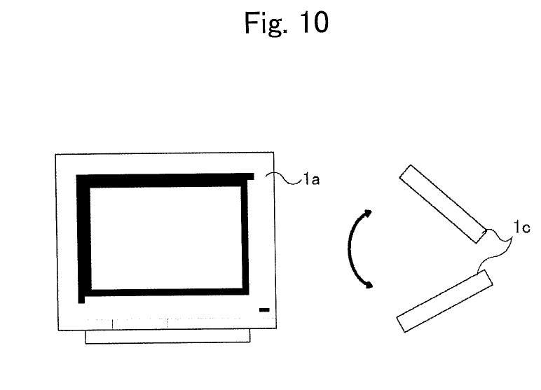

In the case of the present embodiment, the imaging screens 31 to 33 are used to display images taken at multiple angles by the virtual cameras located in the three-dimensional space 3, and the controller 1c is provided with a camera control function to control the imaging angles of the virtual cameras in accordance with the acceleration detected by the acceleration sensor. In this case, as illustrated in FIG. 10, it is possible to display a shot mode screen (a closeup of character's feet, the overall image of the character, the imaging screen 33 and so forth) by tilting the controller 1c downward, display the imaging screen 32 (jump view) by evening out the controller 1c, and display the imaging screen 31 (top view) by tilting the controller is upward.

Meanwhile, when performing the camera control function, the operator does usually not perform a shooting motion so that sound appropriate for the displayed scenery may be output in accordance with the operation of the controller 1c. For example, the cheers and boos of the surrounding gallery may be output when displaying a jump view or top view.

This camera control function is turned on/off by pressing a predetermined button of the controller 1c. The basic screen (game progress screen when a shooting motion is not performed) is displayed when the camera control function is turned on. The camera control function is turned off by pressing the predetermined button for switching to a shooting motion (starting acquiring the first manipulation signal).

The input analysis unit 259 analyzes pressing of a button by user operation, and issues an instruction to switch between the camera control function and the start of inputting the first operating signal. In response to this switch instruction, an input data generation unit 251 and the gauge control unit 253 start a shooting motion. Meanwhile, in the case of the present embodiment, an estimated flight path is determined when the camera control function is switched to the start of the shooting motion. In other words, the estimated flight path is displayed in different ways as illustrated in FIG. 9 by tilting (rotating) the controller 1c when performing the camera control function. This represents the grip on a golf club such that the angle of the club face is estimated from the holding of the golf club to simulate the rotation and variation (fade or draw) of the ball. Then, when the button of the controller 1c is pressed, the input analysis unit 259 detects this operation to switch the camera control function to a shooting motion and determine the estimated flight path at the same time.

Furthermore, the application running unit 25 is provided with the gauge control unit 253, the input data generation unit 251 and the object control unit 252 respectively as modules for generating input data and controlling the objects.

The gauge control unit 253 performs graphic operation such as switching the way of displaying the graphic user interface 344, and serves as a module for inputting the magnitude of impact to the input data generation unit 251 through the controller. The gauge control unit 253 is provided with an impact pointer display unit 253a which controls the motion and display of the impact pointer 344d.

The 2D configuration unit 26 is a module for generating input data from the first operating signal indicative of the input value which varies in accordance with the operation of the controller 1c by the operator, and the second operating signal which modifies the input value. The generated input data is output to the object control unit 252.

On the other hand, the gauge control unit 253 is provided with the functionality of acquiring the position of the target icon 35c which is moved in the screen. The target icon 35c is a symbol pointing to the arrival point of the ball in the three-dimensional space 3 when performing a shooting motion, for example, as illustrated in FIG. 3. Two-dimensionally motion of the target icon 35c in the screen is acquired in accordance with the user operation of the target icon 35c, i.e., this arrival point, and the target point 344h is displayed in accordance with the distance between the player and the target icon 35c.

The object control unit 252 calculates the flying distance of the ball and the coordinates after flying thereof on the basis of the input data which is input. The 3D configuration unit 23 constructs a 3D animation on the basis of the coordinates after flying, and the 2D configuration unit 26 generates a two-dimensional image to be two-dimensionally displayed in each imaging screen which is displayed on the display 11 through the display interface 14.

(Object Operation Method)

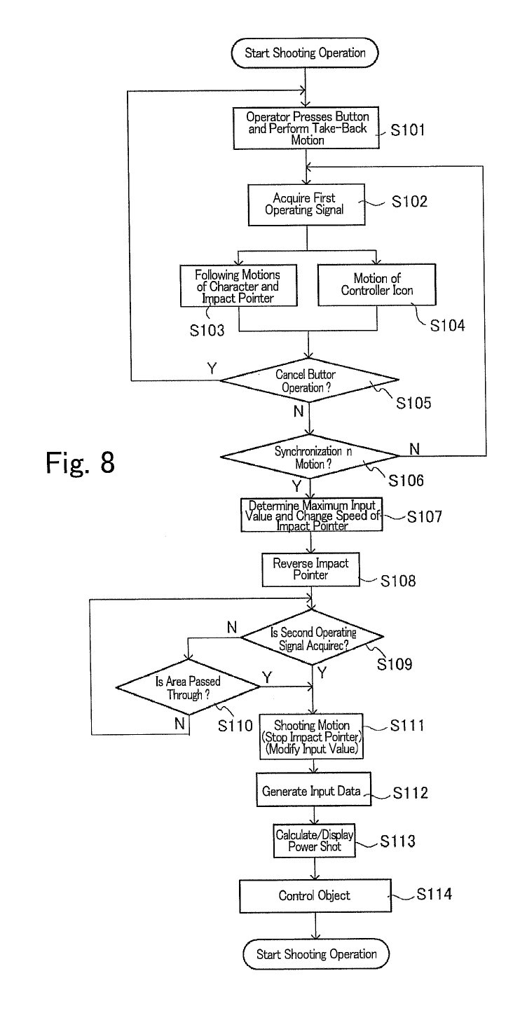

The object operation method of the present invention can be implemented by operating the game device having the structure as described above. FIG. 8 is a flow chart for showing the input process when performing a shooting motion with the game device in accordance with the present invention.

The operator starts a take-back motion in step S101 while pressing the button of the controller 1c, and the camera control function is turned off and switches to a shooting motion (starting acquiring the first manipulation signal). The inclination of the controller 1c is detected, when the button is pressed, to determine the estimated flight path in accordance with the angle of the club face. Then, when the operator perform a take-back motion by swinging up the controller 1c in step S101, the operating signal acquisition unit 255 acquires the first operating signal in accordance with the inclination of the controller 1c in step S102.

The controller icon 344g moves in the right and left direction on the basis of this first operating signal in step S104, and the character slowly begins to perform a take-back motion following the motion of the operator on the basis of the first operating signal as input in step S103. The following motion of this character is represented by the delay (difference) of the impact pointer 344d from the controller icon 344g.

During this process, the operator continues to press the button of the controller 1c (i.e., the “N” branch from step S105). When releasing this button (i.e., the “Y” branch from step S105), the swinging motion is aborted (canceled) to return to step S101 in which the operation can be retried.

While the motion of the character does not yet complete synchronization but generates the difference (i.e., the “N” branch from step S106) rather than cancelled, the first operating signal is continuously acquired, and the operator can change the position of the controller icon 344g by changing the inclination of the controller 1c to adjust the timing of synchronizing with the character, i.e., the input value of the magnitude of impact. Meanwhile, depending upon the lie the ball is located in this case, the texture 344i is displayed on the gauge line 344a in accordance with this lie to pose a limit on the length of the power gauge 344c and a limit on the magnitude of impact input by the take-back motion.

Then, when the operator and the character are synchronized with each other in motion and the impact pointer 344d catches up with the controller icon 344g (i.e., the “Y” branch from step S106, the maximum input value (the maximum magnitude value of impact) corresponding to the first operating signal is determined in step S107 and the motion is automatically switched to the swinging motion. In this swinging motion, the impact pointer 344d reverses and starts moving toward the shot point 344f in step S108. The speed of the impact pointer 344d after reversing varies depending upon the reversing position to increase as the magnitude of impact increases, and further increase as the impact pointer 344d approaches the power shot gauge 344e through the gauge line 344a. That is, while the magnitude of impact becomes greater when the impact pointer 344d moves beyond the gauge line 344a, the speed after reversing becomes so high as to make it difficult to hit the ball with correct timing. In this case, if the reversing position is in the power shot gauge 344e, it is possible to take a power shot.

Next, the impact pointer 344d moves toward the shot point 344f, and comes into the meeting area 344b such that it is ready to accept the second operating signal by repeating a loop process while the impact pointer 344d is moving in the meeting area 344b (i.e., the “N” branch from step S109 and step S110). Then, if the operator performs a shooting motion by swinging the controller 1c while the impact pointer 344d is moving in the meeting area 344b, the second operating signal is acquired (i.e., the “Y” branch from step S109) so that the impact pointer 344d stops in step S111 to complete the shooting motion. Incidentally, the speed of swinging the controller 1c during a shot is calculated on the basis of the distribution and accumulated value of the second operating signal acquired while the impact pointer 344d is moving in the meeting area 344b.

On the other hand, if the impact pointer 344d is moving in the meeting area 344b without acquisition of the second operating signal in step S109 (i.e., the “Y” branch from step S110), the value of the second operating signal is compulsorily determined to perform the shooting motion in step S111. The input value of the compulsory shooting motion may, for example, be determined as a random value or a lowest value.

Input data is generated in step S112 after acquiring both the second operating signal and the first operating signal in step S108. In this case, the value of the first operating signal (the maximum magnitude value of impact) is modified in accordance with the timing, face angle and spinning operation of the shooting motion in step S111, and further increased in accordance with the speed of swinging the controller 1c when acquiring the second operating signal (during the shooting motion). The power increment is displayed by the power shot gauge 344e in step S113 just after the shooting motion.

Then, a series of motion steps is completed after controlling the object (moving the ball) in step S114 on the basis of the flying distance, the shooting direction, the course of the flying ball, the rotation of the ball, the ball behavior after landing and so forth which are calculated in accordance with the generated input data (the maximum magnitude of impact, the modified value).

(Object Control Program)

The game device and object control method as described above in accordance with the present embodiment can be performed in a computer by running an input program described in a predetermined language. Namely, the system having the functionality as described above can easily be implemented by installing the program in a user terminal, a personal computer such as a Web server, an IC chip and so forth, and running the program on the CPU 2. This program can be distributed, for example, through a communication line, or as a package application which can be run on a stand-alone computer.

In addition, such a program can be stored in a computer readable medium, so that the game device and object control method as described above can be implemented with a general purpose computer or a dedicated computer, and the program can be easily maintained, transported and installed.

(Effect/Action)

As has been discussed above, in accordance with the present embodiment, it is possible to determine the timing with the controller 1c having the built-in acceleration sensor, even in the case where a plurality of motions are input as a set of motions such as a take-back motion, a swinging motion and a shooting motion in a golf game, by detecting only the start and end of the motions as the first operating signal and the second operating signal and detecting the timing of switching the motions on the basis of the synchronization with the motion of the character (the second graphic representation). Because of this, in the case of the present embodiment, it is possible to dispense with the operation, for switching between the motions, which is unnecessary when actually doing sports, and acquire important operating signals which determine input data by more similar motions as in actually doing sports.

Particularly, in the case of the present embodiment, the operating signal relating to the next operation is accepted on the basis of the synchronization between the motion of the operator and the motion of the character in the screen, and thereby the operator can spontaneously switch to the next motion for inputting an operating signal while feeling the sense of identity to the character in the screen.

Also, in the case of the above embodiment, it is possible to acquire not only the timing of inputting but also the power (extent) of the motion when accepting the second operating signal through the power shot gauge 344e (the fourth graphic representation), and notify the operator of the result of acquisition to diversify the game scenario. While the maximum magnitude of impact is determined by synchronization with the character during a take-back motion in the case of the present embodiment, the magnitude of impact can be increased by the speed of swinging for inputting the second operating signal, even after failing to perform this take-back motion. As a result, the magnitude of impact can be adjusted also by the speed (strength) of swinging the controller 1c to make the game more exciting, while maintaining the operability in a realistic situation.

Also, the maximum value of the take-back motion is limited by the texture 344i on the gauge line 344a in accordance with the lie the ball is located (the states and conditions of grass and land form around the location), and thereby the condition of the golf course and obstacles can be represented by difficulty in operability to make the game more exciting.

### Modification Example

The present invention is not limited to the above embodiment, but it is possible to add a variety of modification. For example, the second graphic representation of the above embodiment is used to show synchronization between the motion of the operator and the motion of the character for switching to the accepting of the second operating signal. However, for example, the second graphic representation may be such that the time elapsed after the start of inputting the first operating signal is displayed, and when the elapsed time reaches a predetermined time the determination of an input value and the start of accepting the second operating signal are indicated. In this case, it is possible to provide a simple representation of switching between motions in an easy-to-understand manner by indicating switching from a first motion to the next motion with reference to the elapsed time of a timer or the like.

Alternatively, the second graphic representation may be such that the operator is prompted to determine a power level by pressing an A button of the controller 1c or the like. In this case, an impact may be exerted by taking a swinging motion in synchronization with the moving gauge in the third graphic representation. Furthermore, the second graphic representation may represent inversion of the acceleration detected by the acceleration sensor. Namely, switching from a take-back motion to a swinging motion is detected when the inclination and acceleration of the controller 1c start changing backward, and power determination is performed when the acceleration is reversed. Furthermore, the input value of the first operating signal may be determined in advance. For example, the first operating signal may be set to the input value determined when the arrival point of the ball is set up by placing the target icon as described above. In this case, only the timing of the swinging motion has to be detected, but the take-back motion need not be detected.

Incidentally, while the value of the second operating signal is obtained as the accumulated value in the predetermined time in the case of the present embodiment, the instantaneous acceleration (the strength of the swinging motion) may be determined as the value of the second operating signal.

Furthermore, the differential motion between the character and the operator may be represented by displaying double the character. That is to say, the character which is an entity actually operated by the operator and the character following the operator with a delay are doubly displayed. In this case, while the take-back motion (power) is represented by the inclination of the controller 1c, “the degree of delaying and catching up with” is displayed separately therefrom. For example, it is conceivable to display an impact determination gauge of a basic upward motion (to determine at 100%), a gauge decreasing simultaneously when the power is increasing, an explanation which does not associate two objects, i.e., the power and the degree of delaying and catching up with. In this case, the impact determination gauge of the basic upward motion may be decreased in accordance with the angular momentum of the input device.

### BRIEF DESCRIPTION OF DRAWINGS

[FIG. 1] A view for schematically showing the system configuration of the game device in accordance with an embodiment.

[FIG. 2] An explanatory view for showing the operation method of the controller in accordance with the embodiment.

[FIG. 3] An explanatory view for showing the screen layout of the 3D game device in accordance with the embodiment.

[FIG. 4] A block diagram for showing the internal configuration of the game device in accordance with the embodiment.

[FIG. 5] A view for schematically showing the configuration of the GUI in accordance with the embodiment.

[FIG. 6] An explanatory view for showing the operation of the GUI during the shooting motion in accordance with the embodiment.

[FIG. 7] A block diagram for showing the configuration of the impact signal input system of the application running unit 25 in accordance with the embodiment.

[FIG. 8] A flow chart for showing the input process during the shooting motion of the game device in accordance with the embodiment.

[FIG. 9] An explanatory view for showing the displaying of the estimated flight path of the game device in accordance with the embodiment.

[FIG. 10] An explanatory view for showing the camera control function of the game device in accordance with the embodiment.

### EXPLANATION OF REFERENCE

1 . . . gaming hardware
1a . . . display
1b . . . light receiving device
1c . . . controller
2 . . . CPU
3 . . . three-dimensional space
11 . . . display
12 . . . storage device
14 . . . display interface
15 . . . data input/output device
22 . . . screen construction unit
23 . . . 3D configuration unit
24 . . . GUI control unit
25 . . . application running unit
26 . . . 2D configuration unit
27 . . . communication interface
31˜33 . . . imaging screen
34 . . . GUI
35 . . . three-dimensional coordinate system
35a . . . character
35b . . . golf ball
35c . . . target icon
251 . . . input data generation unit
252 . . . object control unit
253 . . . gauge control unit
253a . . . impact pointer display unit
254 . . . character synchronization unit
255 . . . operating signal acquisition unit
256 . . . accumulated value calculating unit
257 . . . acceleration calculating unit
258 . . . inclination calculating unit
259 . . . input analysis unit
344 . . . graphic user interface
344a . . . gauge line
344b . . . meeting area
344c . . . power gauge
344d . . . impact pointer
344e . . . power shot gauge
344f . . . shot point
344g . . . controller icon
344h . . . target point
344i . . . texture
344j . . . estimated flight path

1. A game device for proceeding with a game by inputting an operating signal to operate an object displayed in a screen, comprising:
a controller provided with an acceleration sensor for detecting acceleration in a predetermined direction and configured to output the operating signal in accordance with the acceleration detected by the acceleration sensor;
a user interface control unit configured to control a graphic user interface which is arranged in the screen and used to the display and operation of the game; and
an object control unit configured to change the object in accordance with input data which is calculated on the basis of the operating signal input through the controller;
wherein the input data is generated from a first operating signal indicative of an input value which varies in accordance with the motion of an operator of the controller and a second operating signal for modifying the input value,
the graphic user interface comprising:
a first graphic representation indicative of the input value by changing an image in response to the first operating signal as input;
a second graphic representation indicative of determination of the input value indicated by the first operating signal and the start of accepting the second operating signal by changing an image;
a third graphic representation indicative of the accepting of the second operating signal and the timing of modifying the input value determined by the second graphical representation.

2. The game device as claimed in claim 1 wherein a character moves in the screen as the object,
wherein the character starts a motion following the motion of the operator of the controller on the basis of the first operating signal, and
wherein the second graphic representation indicates the determination of the input value and the start of accepting the second operating signal by difference or synchronization between the motion of the operator and the motion of the character.

3. The game device as claimed in claim 1 wherein the second graphic representation is provided to display the time elapsed after the first operating signal is input, and indicate the determination of the input value and the start of accepting the second operating signal when the elapsed time reaches a predetermined time.

4. The game device as claimed in claim 1 wherein the graphic user interface includes a fourth graphic representation provided to display change in the input value on the basis of the acceleration contained in the second operating signal.

5. The game device as claimed in claim 1 wherein the first graphic representation is provided to display a limit on the input value in accordance the state of the object.

6. The game device as claimed in claim 1 wherein the game is played in a virtual three-dimensional space in which a virtual camera is located to take an image which is displayed in the screen,
wherein the controller is provided with a camera control function for controlling the imaging direction of the virtual camera in accordance with the acceleration detected by the acceleration sensor, and
wherein the object control unit is provided with an operation analysis unit for switching, through analysis of user operation, between the camera control function and a signal acquisition function for acquiring the first operating signal.

7. The game device as claimed in claim 1 wherein a ball changes its position as the object in accordance with input data indicative of the magnitude and direction of impact, the graphic user interface comprising:
a target point operating function used to point to an estimated arrival point of the ball at which the operator aims in the three-dimensional space;
a target point displaying function used to display an image to indicate the magnitude of impact on the ball as a target power required in accordance with the distance to the target point on the first graphic representation; and
an estimated flight path displaying function used to display an estimated flight path of the ball in association with the target power indicated on the first graphic representation.

8. The game device as claimed in claim 1 wherein a ball changes its position as the object in accordance with input data indicative of the magnitude and direction of impact,
wherein the controller detects the inclination of the controller itself in relation to the direction of gravity by the acceleration sensor,
wherein the user interface control unit displays the estimated flight path of the ball in the screen such that the estimated flight path is modified in accordance with the inclination of the controller itself in relation to the direction of gravity, and
wherein the object control unit changes the input data on the basis of the estimated flight path which is changed by the user interface control unit.

9. A game program method for proceeding with a gam; comprising:
using a controller provided with an acceleration sensor for detecting acceleration in a predetermined direction and configured to output the operating signal in accordance with the acceleration detected by the acceleration sensor;
operating an object displayed in a screen through a graphic user interface which is arranged in the screen and used to the display and operation of the game; and
changing the object in accordance with input data which is calculated on the basis of the operating signal input through the controller, the game program method causing a computer to perform:
an input start step of inputting a first operating signal indicative of an input value which varies in accordance with the motion of an operator of the controller and indicating the input value with a first graphic representation by changing an image in response to the first operating signal as input;
an input value determination step of changing an image as a second graphic representation to determine the input value indicated by the first operating signal and indicate the start of accepting the second operating signal;
an input value modification step of changing an image as a third graphic representation to accept the second operating signal and indicate the timing of modifying the input value determined by the second graphical representation; and
an input data calculation step of generating the input data from the input value which is indicated by the first operating signal and varies in accordance with the motion of the operator of the controller, by modifying the input value in accordance with the second operating signal.

10. The game program method as claimed in claim 9 wherein a character moves in the screen as the object,
wherein the character starts a motion following the motion of the operator of the controller on the basis of the first operating signal, and
wherein the second graphic representation indicates the determination of the input value and the start of accepting the second operating signal by difference or synchronization between the motion of the operator and the motion of the character.

11. The game program method as claimed in claim 9 wherein the second graphic representation is provided to display the time elapsed after the first operating signal is input, and indicate the determination of the input value and the start of accepting the second operating signal when the elapsed time reaches a predetermined time.

12. The game program method as claimed in claim 9 wherein a fourth graphic representation is provided in the input value modification step to further display change in the input value on the basis of the acceleration contained in the second operating signal.

13. The game program method as claimed in claim 9 wherein the first graphic representation is provided to display a limit on the input value in accordance the state of the object.

14. The game program method as claimed in claim 9 wherein the game is played in a virtual three-dimensional space,
wherein a virtual camera is located in the virtual three-dimensional space to take an image played in the screen,
wherein the controller is provided with a camera control function for controlling the imaging direction of the virtual camera in accordance with the acceleration detected by the acceleration sensor, and
wherein an operation analysis step is performed in advance of the input start step to switch, through analysis of user operation, between the camera control function and a signal acquisition function for acquiring the first operating signal.

15. The game program method as claimed in claim 9 wherein a ball changes its position as the object in accordance with input data indicative of the magnitude and direction of impact,
the game program method further comprising, in advance of the input start step,
a target point operating step of pointing to an estimated arrival point of the ball at which the operator aims in the three-dimensional space;
a target point displaying step of displaying an image to indicate the magnitude of impact on the ball required as a target power in accordance with the distance to the target point on the first graphic representation; and
an estimated flight path displaying step of displaying an estimated flight path of the ball in association with the target power indicated on the first graphic representation.

16. The game program method as claimed in claim 9 wherein a ball changes its position as the object in accordance with input data indicative of the magnitude and direction of impact,
wherein the controller detects the inclination of the controller itself in relation to the direction of gravity by the acceleration sensor,
wherein, in advance of the input start step, the estimated flight path of the ball is displayed in the screen such that the estimated flight path is modified in accordance with the inclination of the controller itself in relation to the direction of gravity, and
wherein, in the input data calculation step, the input data is changed on the basis of the estimated flight path which is changed by the user interface control unit.

17. An object control method for proceeding with a game by:
using a controller provided with an acceleration sensor for detecting acceleration in a predetermined direction and configured to output the operating signal in accordance with the acceleration detected by the acceleration sensor;
operating an object displayed in a screen through a graphic user interface which is arranged in the screen and used to the display and operation of the game; and
changing the object in accordance with input data which is calculated on the basis of the operating signal input through the controller, the method comprising:
an input start step of inputting a first operating signal indicative of an input value which varies in accordance with the motion of an operator of the controller and indicating the input value with a first graphic representation by changing an image in response to the first operating signal as input;
an input value determination step of changing an image as a second graphic representation to determine the input value indicated by the first operating signal and indicate the start of accepting the second operating signal;
an input value modification step of changing an image as a third graphic representation to accept the second operating signal and indicate the timing of modifying the input value determined by the second graphical representation; and
an input data calculation step of generating the input data from the input value which is indicated by the first operating signal and varies in accordance with the motion of the operator of the controller, by modifying the input value in accordance with the second operating signal.
